(19) United States
(12) Patent Application Publication
(10) Pub. No.: US 2010/0013255 A1
(43) Pub. Date: Jan. 21, 2010

(54) Constrained Layer Damping for Vehicle

(75) Inventors: Maurizio Mantovani, Wiesendangen (CH); Harald Roth, St. Gallen (CH); Dirk Lehmann, Niederneunforn (CH)

Correspondence Address: DORITY & MANNING, P.A., POST OFFICE BOX 1449, GREENVILLE, SC, 29602-1449, US

(73) Assignee: RIETER TECHNOLOGIES AG, Winterthur (CH)

(21) Appl. No.: 12/526,709

(22) PCT Filed: Feb. 12, 2008
(86) PCT No.: PCT/CH08/00052

§ 371 Date: Aug. 11, 2009

(30) Foreign Application Priority Data
Feb. 12, 2007 (EP) 07002904.6

(51) Int. Cl. B60R 13/08

(52) U.S. Cl. 296/1.03

(57) ABSTRACT

The invention relates to a vibration damper for application to a vehicle bottom plate (1), comprising an under floor panel (3) as a constraining layer and a damping layer (2) as a constrained layer, wherein the damping layer (2) has a lower modulus of elasticity than the under floor panel (3), and wherein the damping layer (2) is located between the vehicle bottom plate (1) and the under floor panel (3) when the vibration damper is fixed to the vehicle bottom plate (1). The vibration damper is characterized in that the under floor panel (3) is pre-shaped and stays in this shape when fixed to the vehicle bottom plate (1) and is made of a first polymeric material, and that the damping layer (2) is made of a non-foamy second polymeric or bitumen material and is placed on the under floor panel (3) prior to fixation of the vibration damper to the vehicle bottom plate (1). In addition, the invention relates to a respective damping arrangement and a method of producing a vibration damper.

The present invention concerns a vibration damper for application to a vehicle bottom plate, comprising an under floor panel as a constraining layer and a damping layer as a constrained layer, wherein the damping layer has a lower modulus of elasticity than the under floor panel, and wherein the damping layer is located between the vehicle bottom plate and the under floor panel when the vibration damper is fixed to the vehicle bottom plate. In addition, the invention also relates to a damping arrangement and a method to produce such a vibration damper.

Modern car industry more and more provides the bottom plate of the cars with under floor panels in order to protect the aggregates and components, which are mounted directly underneath the bottom plate, against physical and chemical damages, such as stones and salt. These under floor panels are usually made of plastics material and may comprise reinforcing additives, such as glass fibres. Additionally, these under floor panels are used to diminish the aerodynamic resistance of the vehicle and/or to manage the heat flow directly underneath the bottom plate or underneath the motor compartment and/or to reduce the noise emission and/or transmission. Unfortunately, these light-weight under floor panels tend to vibrate and generate undesired noise.

In order to overcome these deficiencies, EP-A-1520772 proposes to provide such an under floor panel with an additionally elastic material. This elastic material is arranged between the under floor panel and the vehicle's bottom plate and allows to combine acoustic and aerodynamic properties. In particular, this configuration is acoustically behaving in accordance with a classical spring-mass system, wherein the under floor panel is behaving as the mass and the elastic material as the spring. Such spring-mass systems are well known in the art and widely used for acoustic insulations. The disclosed configuration further allows to locally compress the elastic material in order to damp vibrations of the under floor panel. Unfortunately, the local compression of the elastic material reduces the damping performance of the acoustic system at the same time. It appears that this kind of under floor construction has a limited acoustic performance.

Similar disadvantages are also known from all kinds of single-layer dampers, in particular sprayable dampers, which require a rather thick deposit of damper material in order to exhibit a sufficient damping effect. This results in an undesired increase of the weight of the bottom plate and obviously causes additional assembly work and increased assembly costs.

It is also known from EP-A-0077987 to use a constrained three-layer type damper for panels of automotive bodies, in particular for a metallic floor panel. This constrained damper comprises a meltable bonding layer, a viscoelastic layer and a constraining layer laminated such that the viscoelastic layer is intimately sandwiched between the bonding layer and the constraining layer. The constraining layer of this damper is formed of a resin composition comprising an uncured thermosetting resin and an inorganic filler. However, it is not possible to easily adjust and/or optimise the damping performance of this damper.

It is important for the effectiveness of the damping mechanism of a constrained layer damper that during vibration the shear forces within the damping layer are increased and thus an important amount of energy is additionally dissipated.

It is the object of present invention to present a vibration damper and a vibration damping arrangement for an under floor panel, which is lightweight and simple to manufacture, which is simple to assemble and which exhibits an advanced and easy to optimise vibration damping performance.

This object is achieved by the initially mentioned vibration damper in which the under floor panel is pre-shaped and stays in this shape when fixed to the vehicle bottom plate and is made of a first polymeric material, and in which the damping layer is made of a non-foamy second polymeric or bitumen material and is placed on the under floor panel prior to fixation of the vibration damper to the vehicle bottom plate. The damping arrangement according to the invention comprises a vehicle bottom plate and such a vibration damper, which together form a constrained layer damper. The stiffness, the loss factor and the thickness of the different layers are locally adjusted in order to optimise the overall damping performance.

In addition, the above-mentioned object is achieved by a corresponding method for producing such a vibration damper as outlined in the method claim.

For fixing the damping layer onto the vehicle bottom plate, advantageously an adhesive is placed upon the damping layer. Preferably, the adhesive is not a meltable bonding layer. Also, the adhesive advantageously exhibits a high shear stiffness in order not to disturb the effectiveness of the vibration damping; the damping effect may even be enhanced or tuned by the adhesive.

An adhesive can also be used for bonding the under floor panel to the damping layer, where this adhesive likewise has high shear stiffness.

To optimize the constrained damping effect, the under floor panel preferably is made of a stiff material in order to induce shear strains in the damping layer during vibration, wherein the under floor panel is made of a fibre reinforced or non-reinforced thermoplastic, in particular pure polymer fibres or blends of glass and polymer fibres. The panel may also be made by using thermoplastics, especially polypropylene or a polyamide, filled with porous glass spheres. According to one alternative, the under floor panel is made of an injection moulded PP, or a combination of the aforementioned materials.

For example, the under floor panel according to invention can be manufactured by injection moulding. According to one alternative, the under floor panel is made by a direct compounding method.

One preferred under floor panel is made of a glass fibre reinforced material, especially polypropylene or a polyamide.

According to another advantageous alternative, the under floor panel according to the invention is made of natural fibre reinforced material, especially polypropylene or a polyamide. Such natural fibres, which proved to be very suitable, are preferably selected from the group of banana plant, jute, hemp, kenaf, flax, nutshell. The recycling of the vibration damper according to the invention is improved considerably by using natural fibres.

The inventors have found that the under floor panel according to some embodiments of the invention is advantageously made from a thermoplastic which is reinforced by fibres being smaller than 25 mm. In particular, the length of the fibres may be between 1 and 25 mm and more preferably between 10 and 25 mm. In some embodiments, the preferred average fibre length is greater than 10 mm, and—according to some embodiments—is about 20 mm. Moreover, it has been found out that according to some embodiments it is preferred to adjust the degree of fibre filling of the under floor panel between 10 and 50 percent by weight.

In some embodiments, the preferred mass per unit area of the under floor panel according to the invention lies between 1200 and 2500 g/m². The preferred thickness of the under floor layer is between 1 and 3 mm, preferably between 1.2 and 2.5 mm and more preferably between 1.3 and 2.0 mm.

The above parameters advantageously lead to an under floor panel which has a module of elasticity higher than 2000 N/mm², measured according to the Oberst method (DIN EN ISO 6721).

Likewise, the damping material has an important impact on the physical properties of the vibration damper according to the invention. Preferably, the damping material exhibits high adhesion and/or cohesion forces, and is chosen from butyl rubber, sprayable bituminous damper, bitumen mastic, or comprises a pressure sensitive adhesive foil. Alternative materials for the damping layer are standard bitumen/bituminous damping foil, a butyl rubber foil, a bituminous heavy layer, or a combination of some of the aforementioned materials in order to form a layered construction.

Herein, the term “bitumen” is used for modified bitumen such that this bitumen material is adapted to have the desired damping properties. The term “bitumen”, therefore, includes bitumen material with appropriate fillers, including polymeric modifiers resulting in a polymer-modified bitumen.

In some embodiments, the damping layer preferably has a mass per unit area between 1000 and 4000 g/m² and—according to some embodiments—between 2500 and 4000 g/m². Also, the damping layer according to some embodiments preferably exhibits a thickness being between 1.0 and 4 mm.

In some embodiments, the loss factor of the damping layer is preferably adjusted to be greater than 0.1 in a temperature range of Delta T=40° C., measured according to the Oberst method (DIN EN ISO 6721). The shear module at 200 Hz is preferably adjusted to be between 1*10⁵ and 1*10⁸ Pa in a temperature range of −20° C. to 80° C.

In some embodiments, the vibration damper, comprising the under floor panel and the damping layer, preferably exhibits a loss factor of greater than 0.15 in a temperature range of Delta T=60° C., measured according to the Oberst method (DIN EN ISO 6721).

One preferred material choice, which resulted in such a very effective vibration damper, is PP (polypropylene) with a glass fibre content of 0-50% for the under floor panel and bitumen or butyl rubber for the damping layer. With such materials, the above-mentioned value regarding the loss factor have been measured.

According to an advantageous embodiment, the damping layer comprises a locally varying thickness such that it can follow the shape of the floor structure or is assembled of patches with different thickness.

One embodiment is characterised in that the damping layer is perforated in order to allow compression in z-direction, i.e. expansion of the damping material in x,y-direction, during mounting of a strip of a mastic material.

According to one embodiment, areas not covered by the damping layer may exist. In these areas, the under floor panel may be perforated or the under floor panel is replaced by an absorber material. Particularly, this absorber material can be made from a fibre reinforced or non-reinforced thermoplastic fibres material, and in particular from pure polymer fibres or blends of glass and polymer fibres.

The damping arrangement according to the invention comprises a vehicle bottom plate and a vibration damper as described above. The thickness, the loss factor and the stiffness of the layers are optimised with respect to the vibration damping performance.

According to one respective embodiment, the damping layer does not cover all of the space between the bottom plate and the under floor panel, but partially leaves a free space. This free space may be filled instead at least partially with an absorber material, in particular with foam, fibres material, fibre layer stacks, polymer foils, air, or similar.

Although in the preferred embodiment, the damping layer is attached or glued directly to the under floor panel, another advantageous embodiment suggests that a spacer is arranged between the under floor panel and the vehicle bottom plate. This spacer may be located between the under floor panel and the damping layer, or between the damping layer and the vehicle bottom plate. The spacer assures a given distance between the vehicle bottom plate and the under floor panel, wherein the spacer is made from a lightweight material, e.g. a close-cell foam, or is formed by the constraining layer itself.

According to a further embodiment, an insertion layer is arranged on the outside of the under floor panel in order to smooth out the outer shape of this under floor panel, wherein the insertion layer is made of a lightweight material, e.g. absorber material, or is made by the under floor panel material itself.

All of the above embodiments integrate the under floor panel into a constrained damping layer arrangement, which allows to optimise the vibration damping performance of the whole arrangement in view of the thickness, the loss factor and the stiffness of the different layers. This leads to a strong improvement of the damping performance for any given choice of materials and for any given specification. It is an additional advantage of the integrated vibration damping arrangement that the noise in the interior of the vehicle is further reduced.

In order to exemplify the invention reference is made to the following figures, wherein the different layers have properties as discussed above and are made of the described materials:

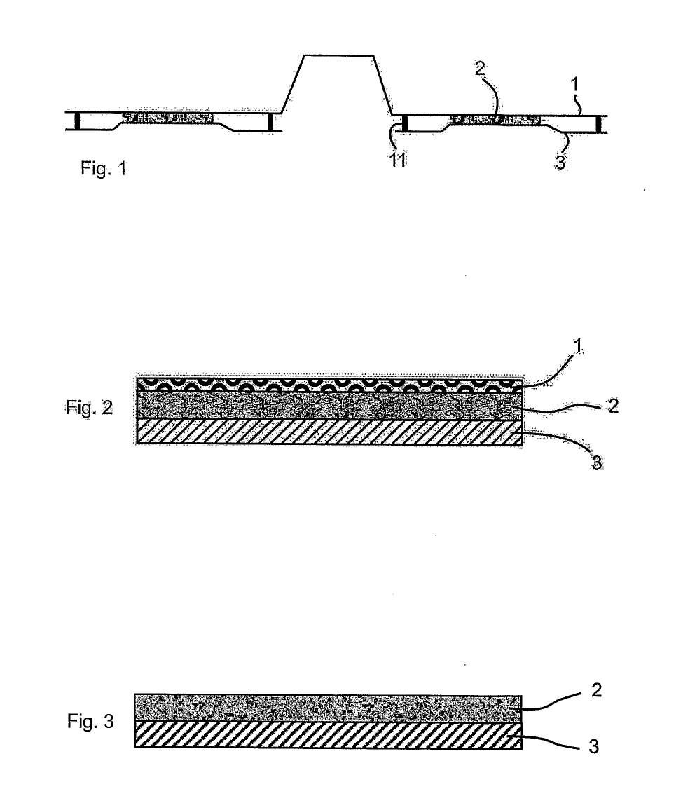

FIG. 1: a schematic and cross sectional view of a vehicle bottom plate comprising a constrained layer damping arrangement according to the invention;

FIGS. 2-6: schematic and cross sectional views of a vibration damper and damping arrangements in accordance with the invention comprising different designs;

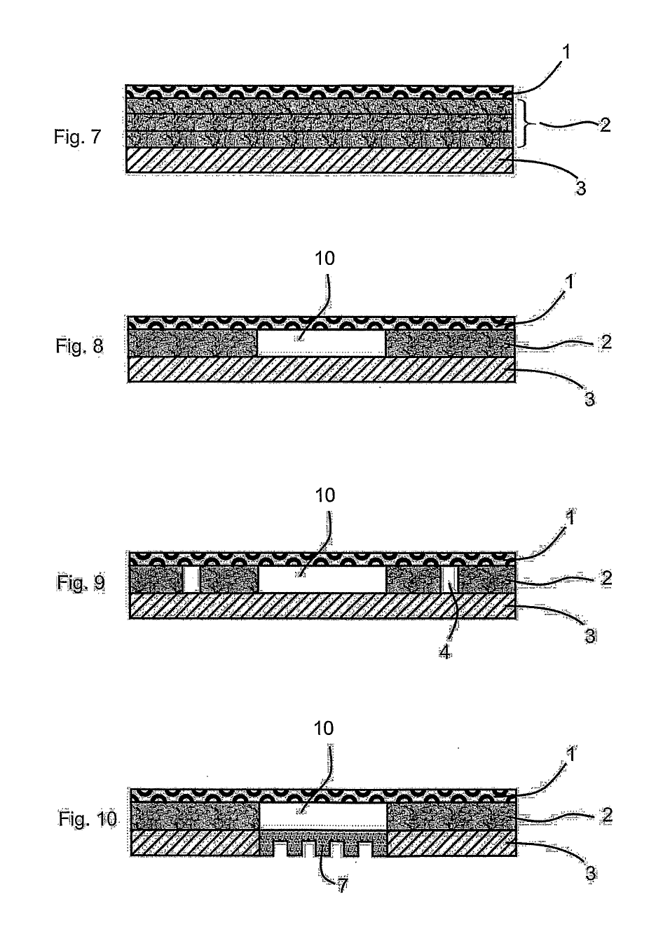

FIGS. 7-11: schematic and cross sectional view of damping arrangements in accordance with the invention comprising different designs of the damping layer, and

FIGS. 12-14: schematic and cross sectional views of damping arrangements in accordance with the invention comprising different designs for an arrangement with varying thicknesses.

FIG. 1 shows a schematic and cross sectional view of a damping arrangement in accordance with the invention. This arrangement comprises a vehicle bottom plate 1, an under floor panel 3 acting as a constraining layer, and a damping layer 2 in between acting as a constrained layer. These layers 1, 2, 3 are forming a constrained layer damper. The under floor panel 3 is spaced and affixed to the vehicle bottom plate 1 by fasteners 11, which do not exhibit particular compression forces to the constrained layer damper. Such fasteners may be, for example, clips, pins, screws, etc. FIG. 2 shows the damping arrangement consisting of the vehicle bottom plate 1, the damping layer 2 and the under floor panel 3 in a magnified view. The vibration damper according to the invention and displayed in FIG. 3 consists in this example of the under floor panel 3 and the damping layer 2 prior to fixation to the vehicle bottom plate 1.

It is advantageous that the damping material exhibits high adhesion and/or cohesion forces in order to assure an adequate surface-to-surface bond. This material (also in respective combinations) is preferably chosen from butyl rubber, sprayable bituminous damper, a bitumen mastic, or is comprising a pressure sensitive adhesive foil.

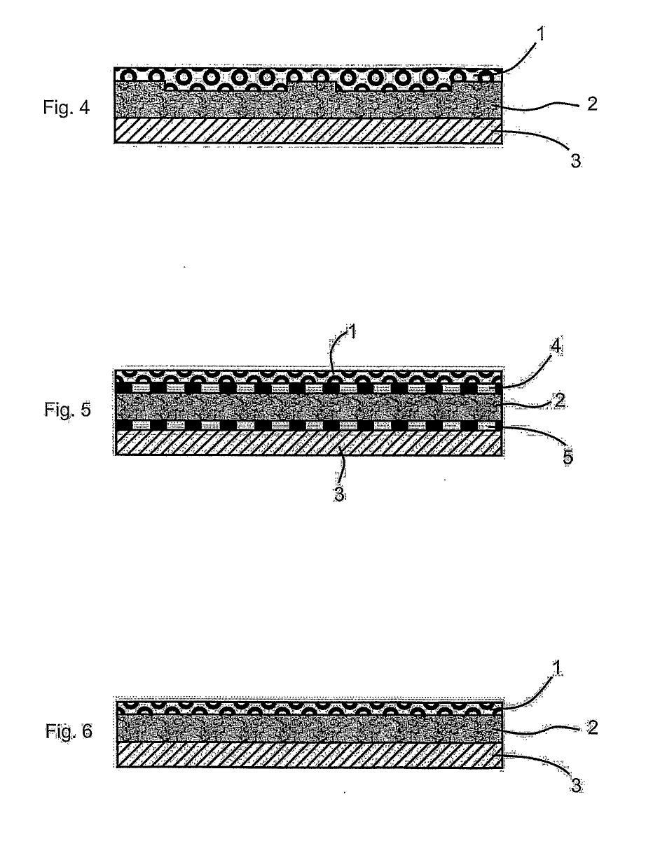

FIG. 4 shows a damping arrangement, wherein the damping layer 2 comprises a locally varying thickness in order to follow the shape of the bottom plate 1. It should be borne in mind that the damping layer 2 may be assembled of patches with different thickness.

FIG. 5 shows a damping arrangement, wherein the bonding between the different layers is achieved by different adhesives 4, 5, which have high shear stiffness. Due to the adhesives 4, 5, the number of usually needed fasteners 11 can be considerably reduced. Even embodiments without fasteners at all are possible if appropriate adhesives are used.

The damping arrangement shown in FIG. 6 comprises a constraining layer material 3, which is made of a stiff material in order to exhibit—during vibration—shear strains in the damping layer 2. The constraining layer 3 is preferably made of a fibre reinforced or non-reinforced thermoplastic fibres material and in particular of a glass fibres or natural fibres reinforced polypropylene material, blends of glass and polymer fibres, pure polymer fibres, an injection moulded PP (polypropylene) material, or a combination of these materials. The fibres advantageously exhibit the above-mentioned properties with respect to length and are made of above-mentioned materials. Special materials for the under floor panel are, e.g., described in WO2001/40025. A lightweight reinforced thermoplastic, which is well known in the art, is described in “Advanced glass-mat thermoplastic composite applications for the automotive industry” of January 2006 from Quadrant Plastic Composites. Other well-suited materials are described in WO2004/088025 and DE102006035361.

The damping arrangement shown in FIG. 7 is a layered construction in accordance with the invention, wherein the damping layer 2 is made of layers of standard bitumen damping foil, butyl rubber, butyl rubber foil, bituminous heavy layer, bitumen mastic, sprayable bituminous damper, or a combination of these materials.

FIG. 8 shows a damping arrangement, wherein the under floor panel 3 is partially covered by the damping layer 2 and a space 10 is created between the under floor panel 3 and the bottom plate 1.

FIG. 9 shows a damping arrangement, wherein the damping layer 2 is perforated in order to allow compression in z-direction (or an expansion of the damping material in x,y-direction) during mounting of a strip of mastic.

FIG. 10 shows a damping arrangement, wherein the layer 3 is replaced at one location by an absorber material 7, in particular by a material, which consists of a blend of glass and polymer fibres or pure polymer fibres, at areas which are not covered by the damping material 2.

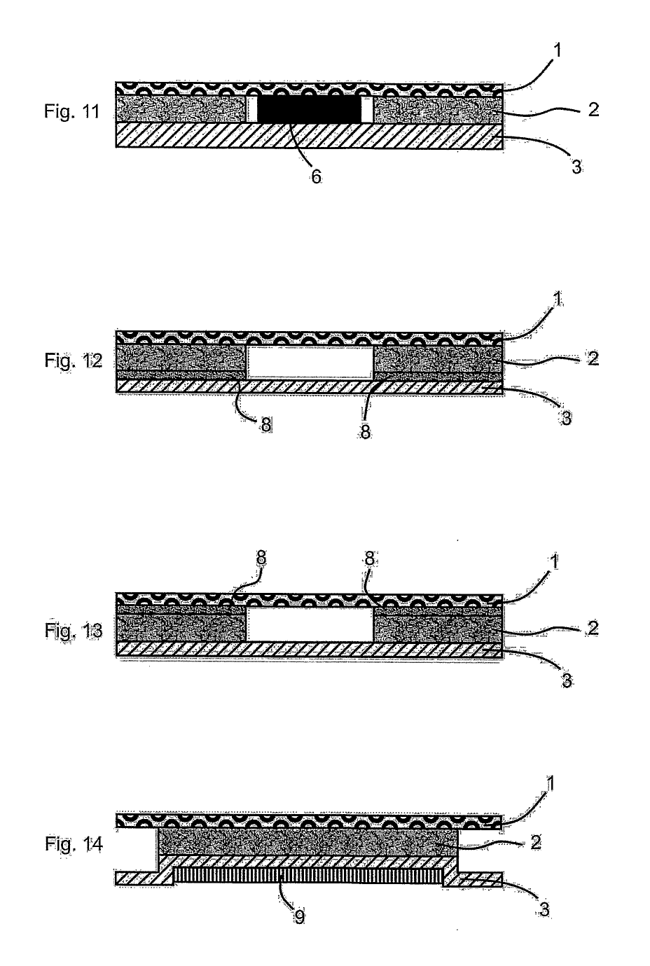

FIG. 11 shows a damping arrangement, wherein the free space 10 between the bottom plate 1 and the under floor panel 3 is filled with an absorber material 6, in particular with fibres material and/or fibre layer stacks (including textile material), foam, foam chambers, polymer foils, air or similar. Fibre layer stacks or polymer foils are well known in the art and for example described in WO2005/023594 or WO2006/105933.

FIG. 12 shows a damping arrangement, wherein a spacer 8 is arranged on the constraining layer 3 in the damped area in order to assure a given distance between the under floor panel 3 and the bottom plate 1. The spacer 8 preferably is a lightweight material, e.g. a close-cell foam, or is formed by the constraining layer itself.

The damping arrangement shown in FIG. 13 comprises a spacer 8 between the damping layer 2 and the vehicle bottom plate 1 to assure a given distance between the bottom plate 1 and the under floor panel 3. Preferably, the spacer 8 is made of a lightweight material, e.g. a close-cell foam, or is made from the bottom plate material.

FIG. 14 shows a damping arrangement, wherein an insertion layer 9 is arranged on the outside of the under floor panel 3 in order to smooth out the outer shape of the under floor panel 3, wherein this insertion layer 9 is made of lightweight material, e.g. absorber material, or is made from the under floor panel material itself.

1. A vibration damper for application to a vehicle bottom plate (1), comprising an under floor panel (3) as a constraining layer and a damping layer (2) as a constrained layer, wherein the damping layer (2) has a lower modulus of elasticity than the under floor panel (3), and wherein the damping layer (2) is located between the vehicle bottom plate (1) and the under floor panel (3) when the vibration damper is fixed to the vehicle bottom plate (1), characterized in that the under floor panel (3) is pre-shaped and stays in this shape when fixed to the vehicle bottom plate (1) and is made of a first polymeric material, and that the damping layer (2) is made of a non-foamy second polymeric or bitumen material and is placed on the under floor panel (3) prior to fixation of the vibration damper to the vehicle bottom plate (1).

2-32. (canceled)
